(19) United States
(12) Patent Application Publication
(10) Pub. No.: US 2023/0313063 A1
(43) Pub. Date: Oct. 5, 2023

(54) POLYALKYLENE GLYCOL FOR REDUCING WHITE ETCHING CRACKS

(71) Applicant: BASF SE, Ludwigshafen am Rhein (DE)

(72) Inventors: Frank RITTIG, Ludwigshafen am Rhein (DE); Rene KOSCHABEK, Ludwigshafen am Rhein (DE)

(21) Appl. No.: 18/024,303

(22) PCT Filed: Aug. 27, 2021
(86) PCT No.: PCT/EP2021/073762

§ 371 Date: Mar. 2, 2023

(30) Foreign Application Priority Data
Sep. 7, 2020 (EP) 20194778.5

(51) Int. Cl. C10M 107/34

(52) U.S. Cl. CPC C10M 107/34; C10N 2020/04

(57) ABSTRACT

The invention relates to a use of a lubricant comprising a polyalkylene glycol for reducing white etching cracks in lubricated metal surfaces; and to a method for reducing white etching cracks in lubricated metal surfaces comprising the steps of lubricating the metal surfaces with a lubricant comprising the polyalkylene glycol.

The invention relates to a use of a lubricant comprising a polyalkylene glycol for reducing white etching cracks in lubricated metal surfaces; and to a method for reducing white etching cracks in lubricated metal surfaces comprising the steps of lubricating the metal surfaces with a lubricant comprising the polyalkylene glycol. Combinations of preferred embodiments with other preferred embodiments are within the scope of the present invention.

Machine elements in mechanical devices are subjected to increasingly harsh operating conditions stemming from ever increasing power densities, thinner lubricating films and often highly variable load profiles. A typical example are wind turbines which experience large load excursions caused by wind gusts, flexing of supporting structures and grid interactions, and are often required to operate under severe environmental conditions. Consequently, achieving reliable operation of mechanical devices, e.g. those employed in wind turbinesis a significant challenge. Given the high maintenance and downtime costs of mechanical devices, such as wind turbines, addressing this challenge is essential.

Inspection of such failed mechanical devices revealed often a presence of widespread crack networks, and microstructural changes in the vicinity of cracks, that appear white under optical microscope when etched. Consequently, such failures are commonly termed “white etching cracks” (WEC).

Object of the present invention was to find ways to reduce white etching cracks in lubricated metal surfaces.

The object was achieved by a use of a lubricant comprising a polyalkylene glycol for reducing white etching cracks in lubricated metal surfaces. The object was also achieved by a method for reducing white etching cracks in lubricated metal surfaces comprising the steps of lubricating the metal surfaces with a lubricant comprising a polyalkylene glycol.

The term “lubricants” usually refers to compositions which are capable of reducing friction between surfaces (preferably metal surfaces), such as surfaces of mechanical devices. A mechanical device may be a mechanism consisting of a device that works on mechanical principles. The lubricant is usually a lubricating liquid, lubricating oil or lubricating grease.

The metal surface is usually made at least in part of a metal, such as a pure metal or a metal alloy. The metal surface is usually the surface of a mechanical device, e.g. of powertrains, drivelines, transmissions, differentials, gears, gear trains, gear sets, gear boxes, bearings, bushings, axles, turbines, compressors, pumps, drive motors, generators. The metal surface is preferably the surface of an gear, preferably the surface of wind turbine gear.

The term “lubricated metal surfaces” usually means that the metal surface in contact with the lubricant.

The white etching cracks (also called WEC) usually refers to cracks in the vicinity of the metal surface (e.g. within up to 10 or up to 5 mm of the metal surface). The cracks are typically a network of cracks in the vicinity of the metal surface. The WEC usually appear white under light microscope when etched.

The use of the lubricant for reducing white etching cracks in lubricated metal surfaces usually means that the WEC are reduced when compared to a polyalkylene glycol free lubricant under the same test conditions, e.g. the same duration, temperature, or wind turbine type.

The concentration of hydrogen deposited in the metal surface is often reduced by the use of the lubricant comprising the polyalkylene glycol. The hydrogen content in the metal surface can be determined by known methods, e.g. by thermal extraction with a carrier gas. The hydrogen is usually reduced in comparison to a polyalkylene glycol free lubricant under the same test conditions, e.g. the same duration, temperature, or wind turbine type.

Suitable polyalkylene glycols are known and often commercially available. The polyalkylene glycol usually comprises C₂-C₁₈ alkylene oxide units in polymerized form. The polyalkylene glycol may comprise only one type of alkylene oxide or a mixture of different alkylene oxide in polymerized form. In case different alkylene oxides are present they may be present in block or randomly polymerized form, preferably in randomly polymerized form.

The polyalkylene glycol preferably comprises ethylene oxide units in randomly polymerized form.

The polyalkylene glycol preferably comprises ethylene oxide units and C₃-C₁₈ alkylene oxide units in randomly polymerized form. In another preferred form the polyalkylene glycol preferably comprises ethylene oxide units and C₃-C₄ alkylene oxide units in randomly polymerized form. In another preferred form the polyalkylene glycol preferably comprises ethylene oxide units and propylene oxide units in randomly polymerized form.

The polyalkylene glycol may comprise at least 10, 20, 25, 30, 35, 40, 45 or 50 wt % ethylene oxide units in polymerized form. The polyalkylene glycol may comprise up to 90, 80, 70, 65, 60 or 55 wt % ethylene oxide units in polymerized form. The polyalkylene glycol may comprise 10 to 90, 20 to 80, 30 to 70, 35 to 65, 40 to 60 or 45 to 45 wt % ethylene oxide units in polymerized form.

The polyalkylene glycol may comprise at least 10, 20, 25, 30, 35, 40, 45 or 50 wt % C₃-C₁₈ alkylene oxide units in polymerized form. The polyalkylene glycol may comprise up to 90, 80, 70, 65, 60 or 55 wt % C₃-C₁₈ alkylene oxide units in polymerized form. The polyalkylene glycol may comprise 10 to 90, 20 to 80, 30 to 70, 35 to 65, 40 to 60 or 45 to 45 wt % C₃-C₁₈ alkylene oxide units in polymerized form.

The polyalkylene glycol may comprise at least 10, 20, 25, 30, 35, 40, 45 or 50 wt % propylene oxide units in polymerized form. The polyalkylene glycol may comprise up to 90, 80, 70, 65, 60 or 55 wt % propylene oxide units in polymerized form. The polyalkylene glycol may comprise 10 to 90, 20 to 80, 30 to 70, 35 to 65, 40 to 60 or 45 to 45 wt % propylene oxide units in polymerized form.

The polyalkylene glycol may comprise at least 25 wt % ethylene oxide units and at least 25 wt % propylene oxide units. In another form the polyalkylene glycol may comprise at least 35 wt % ethylene oxide units and at least 35 wt % propylene oxide units.

The polyalkylene glycol may comprise 20 to 80 wt % ethylene oxide units and 20 to 80 wt % C₃-C₁₈ alkylene oxide units oxide units in polymerized form. In another form the polyalkylene glycol may comprise 30 to 70 wt % ethylene oxide units and 30 to 70 wt % C₃-C₁₈ alkylene oxide units oxide units in polymerized form. In another form the polyalkylene glycol may comprise 30 to 70 wt % ethylene oxide units and 30 to 70 wt % propylene oxide units oxide units in polymerized form.

The polyalkylene glycol has often a molecular weight of 500 to 50 000 g/mol, 600 to 20 000, 700 to 10 000, 800 to 9000 g/mol, 900 to 8000 g/mol, or 1000 to 7000 g/mol. The molecular weight can be determined by e.g. size exclusion chromatography or hydroxyl numbers, where latter is preferred.

The polyalkylene glycol is usually water soluble. The polyalkylene glycol may have a solubility in water at 20° C. of at least 5 g/I, preferably at least 50 g/I.

The lubricant may comprise at least 1, 10, 20, 30, 40, 50, 60, 70, 80, 90 or 95 wt % of the polyalkylene glycol.

The lubricant has usually a viscosity at 40° C. of 5 to 5000 cSt, 50 to 1000 cSt, 150 to 500 cSt, or 200 to 350 cSt.

The lubricant may optionally further comprises in addition to the polyalkylene glycol
a base oil selected from mineral oils, polyalphaolefins, polymerized and interpolymerized olefins, alkyl naphthalenes, alkylene oxide polymers, silicone oils, phosphate ester; and/or
a lubricant additive.

The lubricant preferably comprises less than 20, 15, 10, 5, 3, 2 or 1 wt % of a base oil in addition to the polyalkylene glycol. In another preferred form the lubricant is free of a base oil in addition to the polyalkylene glycol.

The base oil may select from the group consisting of mineral oils (Group I, II or III oils), polyalphaolefins (Group IV oils), polymerized and interpolymerized olefins, alkyl naphthalenes, silicone oils, phosphate esters and carboxylic acid ester (Group V oils). Preferably, the further base oil is selected from Group I, Group II, Group III base oils according to the definition of the API, or mixtures thereof. Definitions for the base oils are the same as those found in the American Petroleum Institute (API) publication “Engine Oil Licensing and Certification System”, Industry Services Department, Fourteenth Edition, December 1996, Addendum 1, December 1998. Said publication categorizes base oils as follows:
a) Group I base oils contain less than 90 percent saturates (ASTM D 2007) and/or greater than 0.03 percent sulfur (ASTM D 2622) and have a viscosity index (ASTM D 2270) greater than or equal to 80 and less than 120.
b) Group II base oils contain greater than or equal to 90 percent saturates and less than or equal to 0.03 percent sulfur and have a viscosity index greater than or equal to 80 and less than 120.
c) Group III base oils contain greater than or equal to 90 percent saturates and less than or equal to 0.03 percent sulfur and have a viscosity index greater than or equal to 120.
d) Group IV base oils contain polyalphaolefins. Polyalphaolefins (PAO) include known PAO materials which typically comprise relatively low molecular weight hydrogenated polymers or oligomers of alphaolefins which include but are not limited to C2 to about C32 alpha-olefins with the C8 to about C16 alphaolefins, such as 1-octene, 1-decene, 1-dodecene and the like being preferred. The preferred polyalphaolefins are poly-1-octene, poly-1-decene, and poly-1-dodecene.
e) Group V base oils contain any base oils not described by Groups I to IV. Examples of Group V base oils include alkyl naphthalenes, silicone oils, carboxylic acid ester and phosphate esters.

Synthetic base oils include hydrocarbon oils and halo-substituted hydrocarbon oils such as pol-ymerized and interpolymerized olefins (e.g., polypropylenes, propylene-isobutylene copolymers, chlorinated polybutylenes, poly(1-hexenes), poly(1-octenes), poly(1-decenes)); alkylbenzenes (e.g., dodecylbenzenes, tetradecylbenzenes, dinonylbenzenes, di(2-ethylhexyl)benzenes); poly-phenyls (e.g., biphenyls, terphenyls, alkylated polyphenols); and alkylated diphenyl ethers and alkylated diphenyl sulfides and derivative, analogs and homologs thereof.

Silicon-based oils such as the polyalkyl-, polyaryl-, polyalkoxy- or polyaryloxysilicone oils and sili-cate oils comprise another useful class of synthetic base oils; such base oils include tetra-ethyl silicate, tetraisopropyl silicate, tetra-(2-ethylhexyl)silicate, tetra-(4-methyl-2-ethyl-hexyl) silicate, tetra-(p-tert-butyl-phenyl) silicate, hexa-(4-methyl-2-ethylhexyl)disiloxane, poly(methyl) siloxanes and poly(methylphenyl)siloxanes. Other synthetic base oils include liquid esters of phosphorous-containing acids (e.g., tricresyl phosphate, trioctyl phosphate, diethyl ester of decylphosphonic acid) and polymeric tetrahydrofurans.

Suitable lubricant additives may be selected from antioxidants, viscosity index improvers, polymeric thickeners, corrosion inhibitors, detergents, dispersants, anti-foam agents, dyes, wear protection additives, extreme pressure additives (EP additives), anti-wear additives (AW additives), friction modifiers, metal deactivators, pour point depressants.

The viscosity index improvers include high molecular weight polymers that increase the relative viscosity of an oil at high temperatures more than they do at low temperatures. Viscosity index improvers include polyacrylates, polymethacrylates, alkylmethacrylates, vinylpyrrolidone/meth-acrylate copolymers, poly vinylpyrrolidones, polybutenes, olefin copolymers such as an ethylene-propylene copolymer or a styrene-butadiene copolymer or polyalkene such as PIB, styrene/acrylate copolymers and polyethers, and combinations thereof. The most common VI improvers are methacrylate polymers and copolymers, acrylate polymers, olefin polymers and copolymers, and styrenebutadiene copolymers. Other examples of the viscosity index improver include polymethacrylate, polyisobutylene, alpha-olefin polymers, alpha-olefin copolymers (e.g., an ethylenepropylene copolymer), polyalkylstyrene, phenol condensates, naphthalene condensates, a styrenebutadiene copolymer and the like. Of these, polymethacrylate having a number average molecular weight of 10000 to 300000, and alpha-olefin polymers or alpha-olefin copolymers having a number average molecular weight of 1000 to 30000, particularly ethylene-alpha-olefin copolymers having a number average molecular weight of 1000 to 10000 are preferred. The viscosity index increasing agents can be added and used individually or in the form of mixtures, conveniently in an amount within the range of from 0.05 to 20.0% by weight, in relation to the weight of the base stock.

Suitable (polymeric) thickeners include, but are not limited to, polyisobutenes (PIB), oligomeric co-polymers (OCPs), polymethacrylates (PMAs), copolymers of styrene and butadiene, or high viscosity esters (complex esters).

Corrosion inhibitors may include various oxygen-, nitrogen-, sulfur-, and phosphorus-containing materials, and may include metal-containing compounds (salts, organometallics, etc.) and nonmetal-containing or ashless materials. Corrosion inhibitors may include, but are not limited to, additive types such as, for example, hydrocarbyl-, aryl-, alkyl-, arylalkyl-, and alkylaryl-versions of detergents (neutral, overbased), sulfonates, phenates, salicylates, alcoholates, carboxylates, salixarates, phosphites, phosphates, thiophosphates, amines, amine salts, amine phosphoric acid salts, amine sulfonic acid salts, alkoxylated amines, etheramines, polyetheramines, amides, imides, azoles, diazoles, triazoles, benzotriazoles, benzothiadoles, mercaptobenzothiazoles, tolyltriazoles (TTZ-type), heterocyclic amines, heterocyclic sulfides, thiazoles, thiadiazoles, mercaptothiadiazoles, dimercaptothiadiazoles (DMTD-type), imidazoles, benzimidazoles, dithiobenzimidazoles, imidazolines, oxazolines, Mannich reactions products, glycidyl ethers, anhydrides, carbamates, thiocarbamates, dithiocarbamates, polyglycols, etc., or mixtures thereof.

Detergents include cleaning agents that adhere to dirt particles, preventing them from attaching to critical surfaces. Detergents may also adhere to the metal surface itself to keep it clean and prevent corrosion from occurring. Detergents include calcium alkylsalicylates, calcium alkylphenates and calcium alkarylsulfonates with alternate metal ions used such as magnesium, barium, or sodium. Examples of the cleaning and dispersing agents which can be used include metal-based detergents such as the neutral and basic alkaline earth metal sulphonates, alkaline earth metal phenates and alkaline earth metal salicylates alkenylsuccinimide and alkenylsuccinimide esters and their borohydrides, phenates, salienius complex detergents and ashless dispersing agents which have been modified with sulphur compounds. These agents can be added and used individually or in the form of mixtures, conveniently in an amount within the range of from ≥0.01 to ≤1.0% by weight in relation to the weight of the base stock; these can also be high total base number (TBN), low TBN, or mixtures of high/low TBN.

Dispersants are lubricant additives that help to prevent sludge, varnish and other deposits from forming on critical surfaces. The dispersant may be a succinimide dispersant (for example N-substituted long chain alkenyl succinimides), a Mannich dispersant, an ester-containing dispersant, a condensation product of a fatty hydrocarbyl monocarboxylic acylating agent with an amine or ammonia, an alkyl amino phenol dispersant, a hydrocarbyl-amine dispersant, a polyether dispersant or a polyetheramine dispersant. In one embodiment, the succinimide dispersant includes a polyisobutylene-substituted succinimide, wherein the polyisobutylene from which the dispersant is derived may have a number average molecular weight of about 400 to about 5000, or of about 950 to about 1600. In one embodiment, the dispersant includes a borated dispersant. Typically, the borated dispersant includes a succinimide dispersant including a polyisobutylene succinimide, wherein the polyisobutylene from which the dispersant is derived may have a number average molecular weight of about 400 to about 5000. Borated dispersants are described in more detail above within the extreme pressure agent description.

Anti-foam agents may be selected from silicones, polyacrylates, and the like. The amount of anti-foam agent in the lubricant compositions described herein may range from ≥0.001 wt.-% to ≤0.1 wt.-% based on the total weight of the formulation. As a further example, an anti-foam agent may be present in an amount from about 0.004 wt.-% to about 0.008 wt.-%.

Suitable extreme pressure agent is a sulfur-containing compound. In one embodiment, the sulfur-containing compound may be a sulfurised olefin, a polysulfide, or mixtures thereof. Examples of the sulfurised olefin include a sulfurised olefin derived from propylene, isobutylene, pentene; an organic sulfide and/or polysulfide including benzyldisulfide; bis-(chlorobenzyl) disulfide; dibutyl tetrasulfide; di-tertiary butyl polysulfide; and sulfurised methyl ester of oleic acid, a sulfurised alkylphenol, a sulfurised dipentene, a sulfurised terpene, a sulfurised Diels-Alder adduct, an alkyl sulphenyl N′N-dialkyl dithiocarbamates; or mixtures thereof. In one embodiment, the sulfurised olefin includes a sulfurised olefin derived from propylene, isobutyllene, pentene or mixtures thereof. In one embodiment the extreme pressure additive sulfur-containing compound includes a dimercaptothiadiazole or derivative, or mixtures thereof. Examples of the dimercaptothiadiazole include compounds such as 2,5-dimercapto-1,3,4-thiadiazole or a hydrocarbyl-substituted 2,5-dimercapto-1,3,4-thiadiazole, or oligomers thereof. The oligomers of hydrocarbyl-substituted 2,5-dimercapto-1,3,4-thiadiazole typically form by forming a sulfur-sulfur bond between 2,5-dimercapto-1,3,4-thiadiazole units to form derivatives or oligomers of two or more of said thiadiazole units. Suitable 2,5-dimercapto-1,3,4-thiadiazole derived compounds include for example 2,5-bis(tert-nonyldithio)-1,3,4-thiadiazole or 2-tert-nonyldithio-5-mercapto-1,3,4-thiadiazole. The number of carbon atoms on the hydrocarbyl substituents of the hydrocarbyl-substituted 2,5-dimercapto-1,3,4-thiadiazole typically include 1 to 30, or 2 to 20, or 3 to 16. Extreme pressure additives include compounds containing boron and/or sulfur and/or phosphorus. The extreme pressure agent may be present in the lubricant compositions at 0 wt.-% to about 20 wt.-%, or at about 0.05 wt.-% to about 10.0 wt.-%, or at about 0.1 wt.-% to about 8 wt.-% of the lubricant composition.

Examples of anti-wear additives include organo borates, organo phosphites such as didodecyl phosphite, organic sulfur-containing compounds such as sulfurized sperm oil or sulfurized terpenes, zinc dialkyl dithiophosphates, zinc diaryl dithiophosphates, phosphosulfurized hydrocarbons and any combinations thereof.

Friction modifiers may include metal-containing compounds or materials as well as ashless compounds or materials, or mixtures thereof. Metal-containing friction modifiers include metal salts or metal-ligand complexes where the metals may include alkali, alkaline earth, or transition group metals. Such metal-containing friction modifiers may also have low-ash characteristics. Transition metals may include Mo, Sb, Sn, Fe, Cu, Zn, and others. Ligands may include hydrocarbyl derivative of alcohols, polyols, glycerols, partial ester glycerols, thiols, carboxylates, carbamates, thiocarbamates, dithiocarbamates, phosphates, thiophosphates, dithiophosphates, amides, imides, amines, thiazoles, thiadiazoles, dithiazoles, diazoles, triazoles, and other polar molecular functional groups containing effective amounts of O, N, S, or P, individually or in combination. In particular, Mo-containing compounds can be particularly effective such as for example Mo-dithiocarbamates, Mo(DTC), Mo-dithiophosphates, Mo(DTP), Mo-amines, Mo (Am), Mo-alcoholates, Mo-alcohol-amides, and the like.

Ashless friction modifiers may also include lubricant materials that contain effective amounts of polar groups, for example, hydroxyl-containing hydrocarbyl base oils, glycerides, partial glycerides, glyceride derivatives, and the like. Polar groups in friction modifiers may include hydrocarbyl groups containing effective amounts of O, N, S, or P, individually or in combination. Other friction modifiers that may be particularly effective include, for example, salts (both ash-containing and ashless derivatives) of fatty acids, fatty alcohols, fatty amides, fatty esters, hydroxyl-containing carboxylates, and comparable synthetic long-chain hydrocarbyl acids, alcohols, amides, esters, hydroxy carboxylates, and the like. In some instances, fatty organic acids, fatty amines, and sulfurized fatty acids may be used as suitable friction modifiers. Examples of friction modifiers include fatty acid esters and amides, organo molybdenum compounds, molybdenum dialkylthiocarbamates and molybdenum dialkyl dithiophosphates.

Suitable metal deactivators include benzotriazoles and derivatives thereof, for example 4- or 5-alkylbenzotriazoles (e.g. triazole) and derivatives thereof, 4,5,6,7-tetrahydrobenzotriazole and 5,5′-methylenebisbenzotriazole; Mannich bases of benzotriazole or triazole, e.g. 1-[bis(2-ethylhexyl) aminomethyl) triazole and 1-[bis(2-ethylhexyl) aminomethyl)benzotriazole; and alkoxyalkylbenzotriazoles such as 1-(nonyloxymethyl)benzotriazole, 1-(1-butoxyethyl) benzotriazole and 1-(1-cyclohexyloxybutyl) triazole, and combinations thereof. Additional non-limiting examples of the one or more metal deactivators include 1,2,4-triazoles and derivatives thereof, for example 3-alkyl(or aryl)-1,2,4-triazoles, and Mannich bases of 1,2,4-triazoles, such as 1-[bis(2-ethylhexyl) aminomethyl-1,2,4-triazole; alkoxyalkyl-1,2,4-triazoles such as 1-(1-butoxyethyl)-1,2,4-triazole; and acylated 3-amino-1,2,4-triazoles, imidazole derivatives, for example 4,4′-methylenebis(2-undecyl-5-methylimidazole) and bis[(N-methyl)imidazol-2-yl]carbinol octyl ether, and combinations thereof. Further non-limiting examples of the one or more metal deactivators include sulfur-containing heterocyclic compounds, for example 2-mercaptobenzothiazole, 2,5-dimercapto-1,3,4-thia-diazole and derivatives thereof; and 3,5-bis[di(2-ethylhexyl) aminomethyl]-1,3,4-thiadiazolin-2-one, and combinations thereof. Even further non-limiting examples of the one or more metal deactivators include amino compounds, for example salicylicdenepropylenediamine, salicylami-noguanidine and salts thereof, and combinations thereof. The one or more metal deactivators are not particularly limited in amount in the composition but are typically present in an amount of from about 0.01 to about 0.1, from about 0.05 to about 0.01, or from about 0.07 to about 0.1, wt.-% based on the weight of the composition. Alternatively, the one or more metal deactivators may be present in amounts of less than about 0.1, of less than about 0.7, or less than about 0.5, wt.-% based on the weight of the composition.

Pour point depressants (PPD) include polymethacrylates, alkylated naphthalene derivatives, and combinations thereof. Commonly used additives such as alkylaromatic polymers and polymethacrylates are also useful for this purpose. Typically, the treat rates range from ≥0.001 wt.-% to ≤1.0 wt.-%, in relation to the weight of the base stock.

Demulsifiers include trialkyl phosphates, and various polymers and copolymers of ethylene glycol, ethylene oxide, propylene oxide, or mixtures thereof. Antioxidants include phenolic antioxidants such as hindered phenolic antioxidants or nonphenolic oxidation inhibitors.

Useful phenolic antioxidants include hindered phenols. These phenolic antioxidants may be ashless (metal-free) phenolic compounds or neutral or basic metal salts of certain phenolic compounds. Typical phenolic antioxidant compounds are the hindered phenolics which are the ones which contain a sterically hindered hydroxyl group, and these include those derivatives of dihydroxy aryl compounds in which the hydroxyl groups are in the o- or p-position to each other. Typical phenolic antioxidants include the hindered phenols substituted with alkyl groups having 6 carbon atoms or more and the alkylene coupled derivatives of these hindered phenols. Examples of phenolic materials of this type 2-t-butyl-4-heptyl phenol; 2-t-butyl-4-octyl phenol; 2-t-butyl-4-dodecyl phenol; 2,6-di-t-butyl-4-heptyl phenol; 2,6-di-t-butyl-4-dodecyl phenol; 2-methyl-6-t-butyl-4-heptyl phenol; and 2-methyl-6-t-butyl-4-dodecyl phenol. Other useful hindered mono-phenolic antioxidants may include for example hindered 2,6-di-alkyl-phenolic propionic ester derivatives. Bis-phenolic antioxidants may also be used in combination with the present invention. Examples of ortho-coupled phenols include: 2,2′-bis(4-heptyl-6-t-butyl-phenol); 2,2′-bis(4-octyl-6-t-butyl-phenol); and 2,2′-bis(4-dodecyl-6-t-butyl-phenol). Para-coupled bisphenols include for example 4,4′-bis(2,6-di-t-butyl phenol) and 4,4′-methylene-bis(2,6-di-t-butyl phenol).

Non-phenolic oxidation inhibitors which may be used include aromatic amine antioxidants and these may be used either as such or in combination with phenolics. Typical examples of nonphenolic antioxidants include: alkylated and non-alkylated aromatic amines such as aromatic monoamines of the formula R⁸R⁹R¹⁰N, where R⁸ is an aliphatic, aromatic or substituted aromatic group, R⁹ is an aromatic or a substituted aromatic group, and R¹⁰ is H, alkyl, aryl or R¹¹S(O)ₓR¹², where R¹¹ is an alkylene, alkenylene, or aralkylene group, R¹² is a higher alkyl group, or an alkenyl, aryl, or alkaryl group, and x is 0, 1 or 2. The aliphatic group R⁸ may contain from 1 to about 20 carbon atoms, and preferably contains from about 6 to 12 carbon atoms. The aliphatic group is a saturated aliphatic group. Preferably, both R⁸ and R⁹ are aromatic or substituted aromatic groups, and the aromatic group may be a fused ring aromatic group such as naphthyl.

Aromatic groups R⁸ and R⁹ may be joined together with other groups such as S. Typical aromatic amines antioxidants have alkyl substituent groups of at least about 6 carbon atoms. Examples of aliphatic groups include hexyl, heptyl, octyl, nonyl, and decyl. Generally, the aliphatic groups will not contain more than about 14 carbon atoms. The general types of amine antioxidants useful in the present compositions include diphenylamines, phenyl naphthylamines, phenothiazines, imidodibenzyls and diphenyl phenylene diamines. Mixtures of two or more aromatic amines are also useful. Polymeric amine antioxidants can also be used. Particular examples of aromatic amine antioxidants useful in the present invention include: p,p′-dioctyldiphenylamine; t-octylphenyl-alpha-naphthylamine; phenyl-alphanaphthylamine; and p-octylphenyl-alpha-naphthylamine. Sulfurized alkyl phenols and alkali or alkaline earth metal salts thereof also are useful antioxidants.

The lubricant can be used in various applications such as light, medium and heavy duty engine oils, industrial engine oils, marine engine oils, automotive engine oils, crankshaft oils, compressor oils, refrigerator oils, hydrocarbon compressor oils, very low-temperature lubricating oils and fats, high temperature lubricating oils and fats, wire rope lubricants, textile machine oils, refrigerator oils, aviation and aerospace lubricants, aviation turbine oils, transmission oils, gas turbine oils, spindle oils, spin oils, traction fluids, transmission oils, plastic transmission oils, passenger car transmission oils, truck transmission oils, industrial transmission oils, industrial gear oils, insulating oils, instrument oils, brake fluids, transmission liquids, shock absorber oils, heat distribution medium oils, transformer oils, fats, chain oils, minimum quantity lubricants for metalworking operations, oil to the warm and cold working, oil for water-based metalworking liquids, oil for neat oil metalworking fluids, oil for semi-synthetic metalworking fluids, oil for synthetic metalworking fluids, drilling detergents for the soil exploration, hydraulic oils, in biodegradable lubricants or lubricating greases or waxes, chain saw oils, release agents, moulding fluids, gun, pistol and rifle lubricants or watch lubricants and food grade approved lubricants.

The invention also relates to a method for reducing white etching cracks in the lubricated metal surfaces comprising the steps of lubricating the metal surfaces with the lubricant comprising the polyalkylene glycol.

### EXAMPLE 1—LUBRICANTS

The following lubricants were used:
Lube PAG-A: commercial lubrianct formulation with polyalkylene glycol comprising a butanol iniated 50 wt % ethylene oxide and 50% propylene oxide in randomly polymerized form copolymer with a kinematic viscosity at 40° C. of about 50 cSt (mol weight approx. 1200 g/mol) and a diethyleneglycol iniated 60 wt % ethylene oxide and 40% propylene oxide in randomly polymerized form copolymer with a kinematic viscosity at 40 of about 1100 cSt (mol weight approx. 6400 g/mol); viscosity at 40° C. 230 mm²/s (ISO 3104); viscosity index about 235; pour point about −40° C.; the lubricant contains commercial additives (1.5-2.5% antiwear additive based on organophosphate and organothiophosphat, partially amineneutralized; 1-3% phenolic and aminic antioxidants; <0.3% further additives (corrosion inhibitors, defoamer)).
Lube PAG-B: Pure polyalkylene glycol comprising 60 wt % ethylene oxide and 40 wt.-% proplylene oxide in randomly polymerized form; viscosity at 40° C. 225 mm²/s (ASTM D445); viscosity index about 230; pour point about −45° C.; water soluble, molecular weight approx. 2400 g/mol; contains no additives.

For comparison, the following lubricants were used:
Lube PAO: Polyalphaolefin, viscosity at 40° C. 48 mm²/s, viscosity at 100° C. 8 mm²/s (ASTM D445); viscosity index about 140; insoluble in water.
Lube COM: commercially available industrial gear oil “MobilGear® SHC XMP 320” from ExxonMobil; based on polyalphaolefin base oil, contains 10-20 wt % isotridecyl adipate, 1-5 wt % methylene bis(dibutyldithiocarbamate), 0.1-1 wt % triphenyl phophorothionat.

### EXAMPLE 2—BALL AND ROLLER TESTING MACHINE

The lubricants were tested on a ball and roller testing machine for testing axial cylindrical roller bearings. The test conditions were as follows: oil volume about 15 ml which was externally heated to 80-90° C., norm force 8 kN, rotation speed 700 min 1, duration 100 h, tested with 10 rolling bodies, maximum Hertz'sche pressure 1930 MPa, during each test Stribeck curves were made in 10 h intervals. The surface of the tested foiling bodies was analyzed under the light microscope and the results are summarized in Table 1 (middle column).

### EXAMPLE 3—ANALYSIS OF MICROSTRUCTURE AND WHITE ETCHING CRACKS

In order to analyse the microstructure of the tested sample of Example 2 for each lubricant tested three cylindrical rollers were cross-section polished on the front surface. For the sectioning the cross-sections were made in 0.5 mm distance. Each cylinder roller was 4 mm broad. The polished cross-sections were etched with alcoholic picric acid before light microscopy to make the grain structure visible and to improve the assessment of the with etching cracks. The results are summarized in Table 1 (right column). The data demonstrated that lubricants based on polyalkylene glycol reduce the white etching cracks.

wTABLE 1

| | Surface | |
|---|---|---|
| Lubricant | damages | White etching cracks WEC |
| Lube PAG-A | No | No WEC |
| Lube PAG-B | Pitting | No WEC, only few fatigue regions |
| | | (also called dark ething regions) |
| Lube PAO | Pitting | WEC found, strong dark etching |
| (comparative) | | regions |
| Lube COM | Micropitting | WEC found. |
| (comparative) | | |

### EXAMPLE 4—HYDROGEN DEPOSITION

The analysis of the hydrogen content in the roller bodies was achieved by thermal extraction with a carrier gas. The samples are molten and the liberated hydrogen analyzed. Calibration standards with 1.9 ppm±0.2 ppm hydrogen were used. Three roller bodies were analyzed for each lubricant after the test of Example 2 after washing them with n-hexane and acetone and drying under nitrogen atmosphere. As reference and initial hydrogen content three roller bodies were analyzed without testing them in Example 2. The increase in hydrogen concentration in the roller bodies tested in Example 2 is summarized in Table 2. The data showed that there is a reduced increase in hydrogen deposition in the roller bodies when polyalkylene glycol based lubricants were used.

TABLE 2

| | Increase of |
|---|---|
| | hydrogen |
| | in roller |
| Lubricant | body |
| Lube PAG-A | 0.33 ppm |
| Lube PAG-B | 0.37 ppm |
| Lube PAO | 0.49 ppm |
| (comparative) | |
| Lube COM | 0.52 ppm |
| (comparative) | |

1.-14. (canceled)

15. A method comprising providing a lubricant comprising a polyalkylene glycol and reducing white etching cracks in lubricated metal surfaces.

16. The method according to claim 15, wherein the lubricant comprises at least 50 wt % of the polyalkylene glycol.

17. The method according to claim 15, wherein the polyalkylene glycol comprises ethylene oxide units in randomly polymerized form.

18. The method according to claim 15, wherein the polyalkylene glycol comprises ethylene oxide units and C₃-C₁₈ alkylene oxide units in randomly polymerized form.

19. The method according to claim 15, wherein the polyalkylene glycol comprises ethylene oxide units and propylene oxide units in randomly polymerized form.

20. The method according to claim 15, wherein the polyalkylene glycol comprises at least 25 wt % ethylene oxide units and at least 25 wt % propylene oxide units.

21. The method according to claim 15, wherein the polyalkylene glycol comprises 35 to 65 wt % ethylene oxide units in polymerized form.

22. The method according to claim 15, wherein the polyalkylene glycol comprises 35 to 65 wt % propylene oxide units.

23. The method according to claim 15, wherein the lubricant has a viscosity at 40° C. of 150 to 500 cSt.

24. The method according to claim 15, wherein the polyalkylene glycol has a solubility in water at 20° C. of at least 5 g/l.

25. The method according to claim 15, wherein the polyalkylene glycol has a molecular weight of 700 to 10 000 g/mol.

26. The method according to claim 15, wherein the concentration of hydrogen deposited in the metal surface is reduced.

27. The method according to claim 15, wherein the metal surface is the surface of a gear.

28. The method according to claim 15, wherein the metal surface is the surface of a wind turbine gear.

29. A method for reducing white etching cracks in lubricated metal surfaces comprising the steps of lubricating the metal surfaces with a lubricant comprising a polyalkylene glycol.
